(19) United States
(12) Patent Application Publication
(10) Pub. No.: US 2026/0361496 A1
(43) Pub. Date: Nov. 12, 2026

(54) ENHANCED METHODS AND SYSTEMS FOR SIGNALING EXTENSIONS OF BASE LISTS IN WIRELESS COMMUNICATIONS

(71) Applicant: QUALCOMM Incorporated, San Diego, CA (US)

(72) Inventors: Umesh Phuyal, San Diego, CA (US); Mona Agrawal, San Diego, CA (US); Bharat Shrestha, San Diego, CA (US)

(21) Appl. No.: 19/202,912

(22) Filed: May 8, 2025

(51) Int. Cl. H04L 5/00; H04L 27/26; H04W 28/02

(52) U.S. Cl. CPC H04L 5/0053; H04L 27/2605; H04W 28/0215

(57) ABSTRACT

This disclosure provides systems, methods, and devices for wireless communication that support enhanced parallel list coding operations. In a first aspect, an apparatus for wireless communication includes at least one processor and a memory. The at least one processor is configured to cause the apparatus to: identify index indication information for an extension list of a base list, wherein the extension list includes a different amount of elements from the base list, and wherein the index indication information indicates a presence or absence of one or more elements of the extension list; encode extension list information representing the extension list based on the index indication information to generate encoded extension list information including a list with a different amount of encoded elements from the base list; and transmit the encoded extension list information and the index indication information. Other aspects and features are also claimed and described.

### TECHNICAL FIELD

Aspects of the present disclosure relate generally to wireless communication systems, and more particularly, to enhanced operations for coding of list extensions (such as extension lists and also referred to as parallel lists) in wireless communications, such as in radio resource control (RRC) signaling. Some features may enable and provide improved communications, including reduced signaling overhead and improved signaling efficiency when transmitting data in parallel lists with variable size lists.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes: identifying index indication information for an extension list of a base list, wherein the extension list includes a different amount of elements from the base list, and wherein the index indication information indicates a presence or absence of one or more elements of the extension list; encoding extension list information representing the extension list based on the index indication information to generate encoded extension list information including a list with a different amount of encoded elements from the base list; and transmitting the encoded extension list information and the index indication information.

In an additional aspect of the disclosure, an apparatus configured for wireless communication is disclosed. The apparatus includes a processing system including one or more processors and one or more memories coupled to the one or more processors. The processing system is configured to cause the apparatus to: identify index indication information for an extension list of a base list, wherein the extension list includes a different amount of elements from the base list, and wherein the index indication information indicates a presence or absence of one or more elements of the extension list; encode extension list information representing the extension list based on the index indication information to generate encoded extension list information including a list with a different amount of encoded elements from the base list; and transmit the encoded extension list information and the index indication information.

In another aspect of the disclosure, a method of wireless communication includes: receive encoded extension list information, wherein the encoded extension list information indicates an extension list including a different amount of elements from a base list in which the extension list extends from; receive index indication information corresponding to the extension list and indicating a presence or absence of one or more elements of the extension list; decode the encoded extension list information based on the index indication information to generate extension list information; and operate based on the generated decoded extension list information.

In an additional aspect of the disclosure, an apparatus configured for wireless communication is disclosed. The apparatus includes a processing system including one or more processors and one or more memories coupled to the one or more processors. The processing system is configured to cause the apparatus to: receive encoded extension list information, wherein the encoded extension list information indicates an extension list including a different amount of elements from a base list in which the extension list extends from; receive index indication information corresponding to the extension list and indicating a presence or absence of one or more elements of the extension list; decode the encoded extension list information based on the index indication information to generate extension list information; and operate based on the generated decoded extension list information.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3A is a block diagram illustrating an example of a parallel list according to one or more aspects.

FIG. 3B is timing diagram illustrating an example process for transmitting a parallel list according to one or more aspects.

FIG. 3C is a diagram illustrating an example of a parallel list for UE capability information according to one or more aspects.

FIG. 4 is a block diagram illustrating an example wireless communication system that supports enhanced parallel list coding operations according to one or more aspects.

FIG. 5 is a timing diagram illustrating an example process that supports enhanced parallel list coding operations according to one or more aspects.

FIG. 6 is a block diagram illustrating an example of configuration information including an enhanced encoded parallel list and index information according to one or more aspects.

FIGS. 7A-7C are each a block diagram illustrating an example of an enhanced encoded parallel list and corresponding index information according to one or more aspects.

FIGS. 8A-8D are block diagrams illustrating an example of index indication information and corresponding element indications according to one or more aspects.

FIGS. 9A and 9B are each a diagram illustrating an example of a macro for index indication information according to one or more aspects.

FIG. 9C is a diagram illustrating an example of a format for an enhanced parallel list utilizing the macro of FIG. 9A or 9B according to one or more aspects.

FIG. 10 is a flow diagram illustrating an example process that supports enhanced parallel list coding operations according to one or more aspects.

FIG. 11 is a block diagram of an example UE that supports enhanced parallel list coding operations according to one or more aspects.

FIG. 12 is a block diagram of an example base station that supports enhanced parallel list coding operations according to one or more aspects.

Like reference numbers and designations in the various drawings indicate like elements.

### DETAILED DESCRIPTION

Abstract Syntax Notation One (ASN.1) is a standard interface description language (IDL) for defining data structures that can be serialized and deserialized in a cross-platform way. It is broadly used in telecommunications and computer networking. Protocol developers define data structures in ASN.1 modules, which are generally a section of a broader standards document written in the ASN.1 language. The advantage is that the ASN.1 description of the data encoding is independent of a particular computer or programming language. Because ASN.1 is both human-readable and machine-readable, an ASN.1 compiler can compile modules into libraries of code, codecs, that decode or encode the data structures.

In wireless communications, ASN.1 encoding is often used for system message encoding. For example, cellular networks use ASN.1 encoding to encode RRC messages. A pre-defined ASN.1 schema is used by both the transmitter and the receiver to encode and decode RRC messages. While ASN.1 coding is a highly efficient method, ASN.1 coding has some efficiency shortcomings, such as when handling variable size parallel lists. When fields are added to a list element structure, an extension marker is normally preferable if available. If no extension marker is available or if overhead or other considerations prevent using the extension marker, an extension structure is typically created for the new fields, and a parallel extension list is introduced to hold the new structures. The field description table typically indicates that the extension list (aka extended list, parallel list, or list of extended/extension elements) contains the same number of entries, and in the same order, as the original list (i.e., a base or master list). Examples of base lists and extension lists thereof (a parallel list of or to the base list) are provided in Section A.4.3.6 of 3GPP TS 38.331.

For example, when using ASN.1 coding for a set of lists in parallel format, a header is included for the set of lists to indicate a size of each list of the set. In such lists, each of the extension lists have the same number of elements as the base list and these elements must be included in each subsequent/extension list, and in the same order, even when some elements in the original list do not need values to be signaled for extended parameters/candidate values/fields in the subsequent/extension lists. Even when these elements need not be signaled, the signaling structure is still included in the set of lists resulting in signaling overhead even when a negative indication is being made (e.g. absence of the field is being indicated). This can lead to significant overhead in parallel lists, such as for RRC messages, e.g., as DL configuration messages, UL reporting messages, and UE capability messages, due to the large amount of elements in the list and the potential for a large number of absent elements. For example, the list of elements supported for the bandcomb information element can be up to 65536 long and certain lists may only include a few active elements. However, the coding format of parallel lists still will signal the inactive or absent elements, and that increases the signaling overhead. Thus, the encoding overhead and waste can be substantial for parallel lists, and it is only expected to grow with each generation and release thereof.

In the aspects described herein, efficiency enhancements for coding sets of lists in parallel format are described to reduce waste and active signaling of absent elements or redundant elements. For example, extension schemes and indexes for indicating the presence or absence of extensions and/or elements can be used to reduce or eliminate the need to include the same number of elements in each extension list of the set of lists. Thus, variable size extension list (variable size parallel lists) can be encoded to have variable size lists, i.e., one or more lists with different amounts of elements. Accordingly, the number of bits used to transmit a set of lists in parallel format can be greatly reduced, which can reduce the overall message size of messages that include parallel lists, which can significantly reduce network overhead and power consumption.

In the aspects described herein, various techniques are described for indicating the element(s) present or omitted from the parallel lists such that the size of the parallel lists can be reduced. The enhanced parallel list coding operations utilize corresponding index indication information to indicate one or more elements of a particular list that may be omitted or present such that a decoder is able to properly decode or parse the variable size parallel lists of a set of lists in parallel format using the index indication information. This enables a decoder of a receiving device to make sense of the omitted bits and elements and identify which of the included bits correspond to which elements of the static amount of elements and order thereof generally inherent in conventional parallel lists.

In the aspects described herein, the index indication information may be in different formats. For example, the index indication information may be used to identify the elements that are present in one or more extension lists of a set of lists in parallel format, but the index indication information itself may provide a positive indication of elements that are present or a negative indication of elements that are omitted (not present). Additionally, the index indication information may include a complex indication that can be used to indicate which elements are and are not present in some other aspects. As some illustrative examples, the index indication information may include one or more starting index indication(s), ending index indication(s), range indication(s), or all element indications.

In the aspects described herein, the index indication information may be provided to a receiving device in different ways. For example, the index indication information may be provided with the parallel list or separate from the parallel list. To illustrate, the index indication information may be sent in the same transmission (or message thereof) as the parallel list or in a different transmission from the parallel list. When sent separately from the parallel list, the index indication information may be sent as side information. When sent with the parallel list, the index indication information may be sent separate from (e.g., outside) the parallel list or inside the parallel list. To illustrate, when separate from the index indication information may be within a separate information element (IE) of configuration or reporting information that also includes the parallel list but not within the parallel list itself. Alternatively, when the index indication information is sent with the parallel list itself, the index indication information may be sent with the corresponding list or above the lists and may be relevant to multiple elements of the parallel list and/or relevant to multiple parallel lists of the same original (base) list.

The enhanced coding operations for parallel lists solve the technical problem of signaling waste and overhead in coding variable size parallel lists, and the various technical solutions describe herein provide various technical benefits for coding operations for parallel lists. Generally, the technical solution of providing index indication information for the parallel list information enables solving the technical problem of parallel lists that the static header enforces a strict, static size of a base list for each extension/parallel list of the set of lists, which often leads to waste in signaling when put into actual practice for wireless communication when the set of lists include redundant and/or absent elements.

The various different technical solutions of the individual index indications described herein and/or the various different ways for providing the index indications for the parallel list(s) to the receiving device also solve technical problems and provide additional technical benefits, individually and in combination. To illustrate, the parallel lists that need to be encoded are varied, some may be static and some may be dynamic or unique and they may contain varying amounts of elements to omit. Each index indication scheme and distribution scheme for the index indication has its own benefits, as described below, and also when combined together offer a more flexible and complete encoding solution for handling all of the different types of parallel lists (large, small, many absent/redundant elements, few absent/redundant element, large blocks of contiguous present or absent elements, or multiple non-contiguous present or absent element, etc.). As an illustrative example a starting or ending index indication is simpler for a coder to implement and has less overhead as compared to more complicated indexation which use ranges, mixtures of indications, or an all element indication or element index indication, and may offer better coding efficiency for large amounts of absent or redundant elements at a beginning of a list of elements or end of list of elements. Conversely, a more complicated index indication scheme may require more processing resources and take up more signaling overhead, but may offer better coding efficiency for varying lists and lists with sparse non-contiguous elements to include or exclude.

Similarly, the different distribution schemes for the index indication information each have their own benefits, as described below, but when combined together offer a more flexible and complete encoding solution for handling all of the different types of parallel list formats. For example, providing the index information above the lists or outside of the parallel list(s) may enable utilizing macros or function calls, and utilizing macros and functional may be a cleaner solution for implementing the index indication information. Alternatively, providing the index indication information with each list offers a more straightforward and less complicated solution. Using mandatory or optional fields can either increase or decrease signaling overhead at the cost of flexibility. Thus, by using one or more of the techniques described herein a more or most efficient coding solution can be achieved for each type or format of parallel list, which enables the largest reduction in signaling overhead and power consumption, which in turn improves network efficiency and user experience.

The detailed description set forth below, in connection with the appended, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1 M nodes/km²), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 millisecond (ms)), and users with wide ranges of mobility or lack thereof; and (3) with enhanced mobile broadband including extreme high capacity (e.g., ~10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

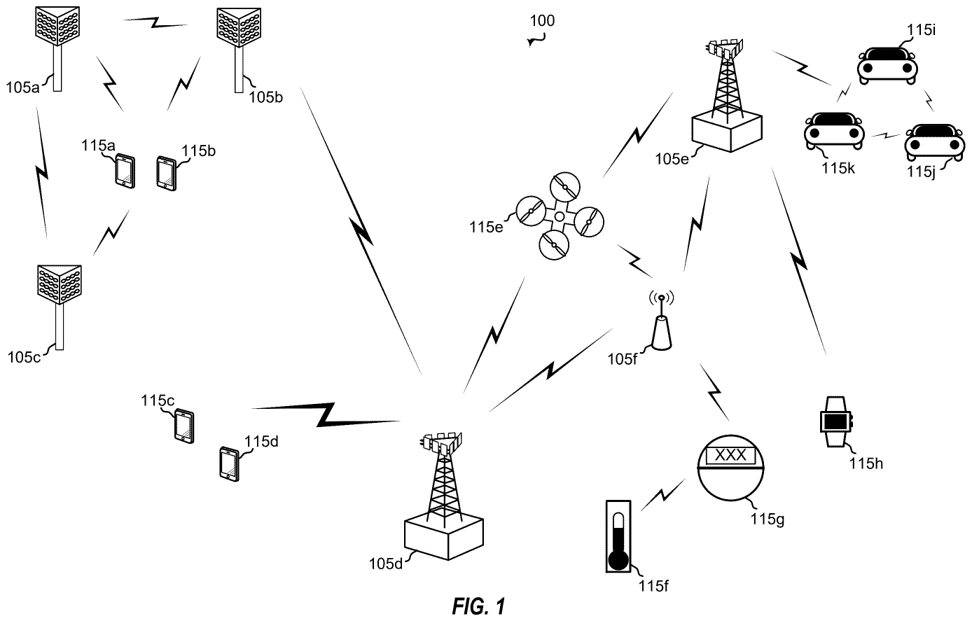

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

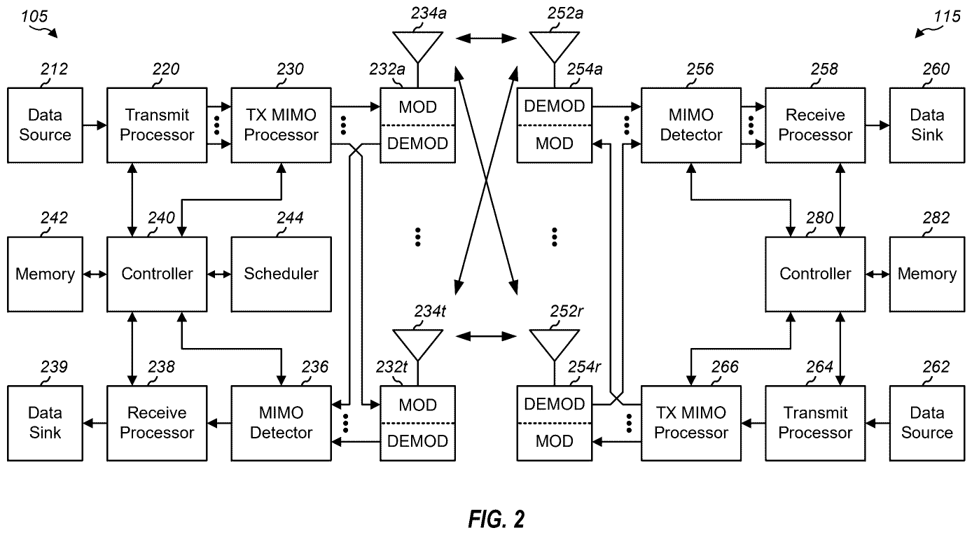

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

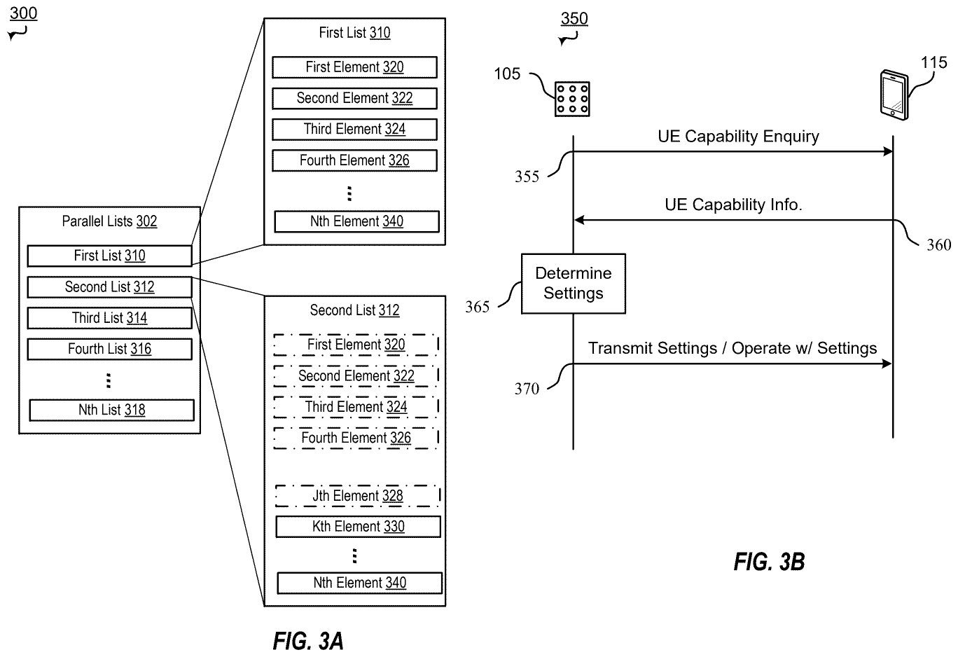

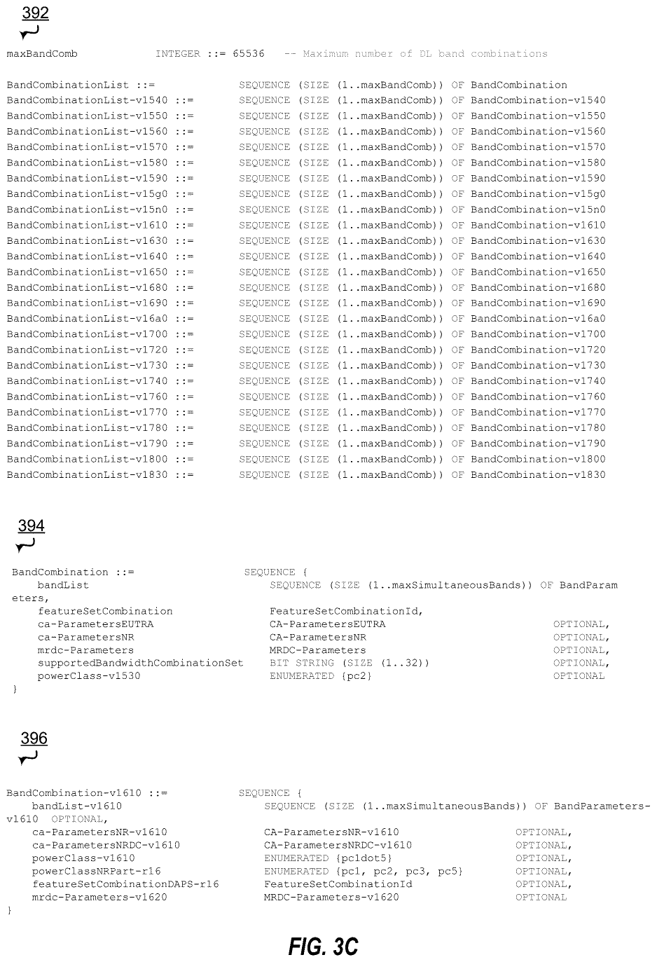

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 3-13, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Referring to FIG. 3A, a block diagram demonstrating an example of parallel lists according to one or more aspects is illustrated. In wireless communications, parallel lists can be used to convey information between devices that includes a plurality of lists with a similar amount and type of elements, and these elements are often referred to as extension elements and are included in extension lists of a master (or original) list of the plurality of lists (e.g., a set of lists in parallel format). Parallel lists are often used to encode and transfer information that may have repetitive or similar elements and illustrative, non-limiting examples of such information is configuration information, reporting information, etc. In FIG. 3A, a block diagram 300 of a simplified set of lists in parallel format is illustrated, along with diagrams for a base list and an extension list of the set of lists.

As illustrated in the example of FIG. 3A, parallel lists 302 are shown that include a plurality of lists (310-318) in parallel format. The parallel lists 302 include a base list (e.g., original or master list), as well as extensions of the base or original list, and these extensions are referred to as extension lists or colloquially as parallel lists. As illustrated in FIG. 3A, the parallel lists 302 include N lists and have a first list 310 (which is the base list, such as a master list or the original list), and a plurality of extension lists of or associated with the first list 310. The extension lists in FIG. 3A are a second list 312, a third list 314, a fourth list 316, etc., though an Nth list 318, and each may be referred to as extension of or extending from the base list, i.e., the first list 310 in this example. Each list of the parallel lists 302 may have a variable amount of elements that are present or actively signaled. However, when each list is encoded with a parallel list format or by using a header that includes a set list or amount of elements to save on encoding overhead, some lists may have many missing or not configured elements (referred to as absent elements) which are still actively signaled, and which still occupy space or require bits for representation and increase signaling overhead.

In FIG. 3A, an example base list of the parallel lists 302 is shown, first list 310, that includes a plurality of elements (320-340). As illustrated in FIG. 3A, the first list 310 includes N elements and has elements of a first element 320, a second element 322, a third element 324, a fourth element 326, etc., though an Nth element 340.

In FIG. 3A, an example extension list (also called a parallel list) of the parallel lists 302 is shown, second list 312, that includes a plurality of elements (320-340). As illustrated in FIG. 3A, the second list 312 includes N elements and has elements of a first element 320, a second element 322, a third element 324, a fourth element 326, etc., though an Nth element 340. In some aspects, such as in the example of FIG. 3A, the second list 312 may be an extension list of the first list 310 and have limited configuration for the elements. For example, the second list 312 may not have any active configuration information for the elements 320-328, that is from the first element 320 to a Jth element 328 and as shown in dashes. The second list 312 may only have active configuration information for the elements 330-340, that is from a Kth element 330 to the Nth element 340 shown in solid lines. However, because of the format for encoding parallel lists, the second list 312 may be signaled and encoded by including bit values for the absent element of the elements 320-328, that is from the first element 320 to a Jth element 328. Signaling all of these absent elements increases signaling overhead and waste, and reduces network efficiency and increases latency.

Although a simplified example of parallel lists is illustrated in the example of FIG. 3A, the problem is only exacerbated when larger and/or nested parallel lists are used, such as parallel lists that include additional parallel lists as elements (e.g., one or more of the elements illustrated in FIG. 3A is a list of elements itself or another parallel list). An example of parallel lists for band configuration information and a transfer thereof is illustrated in FIGS. 3B and 3C.

Referring to FIG. 3B, FIG. 3B is a timing diagram 350 illustrating a wireless communication system that supports enhanced parallel list coding operations according to one or more aspects. The example of FIG. 3B corresponds to an example of encoding a parallel list for UE capability information, such as band combination information, as part of a UE capability enquiry exchange.

Prior to 355, the base station 105 and the UE 115 establish a Uu communication link (also referred to as Uu link or UL/DL link). For example, the UE 115 may perform RRC, RACH, and/or connection establishment operations to establish (or re-establish) an uplink and downlink communication link with a node of a network, such as base station 105. In some implementations, the communication link may be established as part of a handover operation or through another UE. The base station 105 and UE 115 may communicate higher layer signaling, such as RRC signaling (e.g., a RRC transmission or message) or control layer signaling, to establish the connection and link. After establishing the Uu communication link, the base station 105 and the UE 115 may communicate or exchange transmissions at 525. For example, the UE 115 may receive downlink transmissions from the base station 105 and/or transmit uplink transmissions to the base station 105, such as to communicate data.

At 355, the base station 105 transmits a UE capability enquiry message to the UE 115. For example, the base station 105 may transmit a UE capability enquiry transmission to the UE to request capability responsive to the UE connecting to the base station 105 (e.g., transitioning to RRC Connected Mode). The UE capability enquiry transmission may include or correspond to a unicast transmission or a broadcast transmission. For example, the UE capability enquiry transmission may correspond to or be part of a SIB message, such as a SIB1-SIB9 transmission. As another example, the UE capability enquiry transmission may include or correspond to a DL transmission, such as PDSCH, that includes the UE capability enquiry information for the UE 115.

At 360, the UE 115 transmits UE capability information to the base station 105 responsive to the UE capability enquiry message. For example, the UE 115 may transmit UE capability information in a transmits UE capability information message or transmission. The UE capability information indicates settings and configurations that the UE is capable of performing and instructs the network on how to schedule and/or interact with the UE 115.

At 365, the base station 105 decodes the UE capability information to identify the signaled capabilities of the UE 115. For example, the base station 105 parses the UE capability information using an ANS.1 decoder to decode the UE capability information, including any parallel lists thereof, such as the parallel list illustrated in FIG. 3C. The base station 105 identifies settings for the UE 115 based on the decoded the UE capability information. As the encoded parallel list from the UE 115 encodes absent configurations using active indications or bits, the bandwidth required to signal the UE capability information is larger and includes many wasted or absent indications, as described with reference to FIGS. 3A and 3C.

At 370, the base station 105 transmit the identified settings information to the UE 115, and the base station 105 and the UE 115 operate according to the settings. For example, the base station 105 and UE 115 receive and transmit uplink and downlink transmissions based on signaled RRC configuration information and/or grant information (e.g., PDCCH/DCI transmissions) from the network.

Although the example of FIG. 3 includes a Uu example for parallel lists in the UE capability information (e.g., bandcombination configuration information), parallel lists are used in other contexts in cellular networks and systems and in other types of information For example, capability information may be exchanged between UEs via a PC5 link (e.g., sidelink) for controlling sidelink operations, and capability information may be exchanged between base stations via a network link (e.g., backhaul or wireless) for network or inter-cell operations. Similarly, parallel lists may be used in other contexts, e.g., for other types of information, such as in dedicated RRC configuration messages, System Information Broadcast (SIB) messages, measurement and reporting configurations, reporting information, paging message, etc. As illustrative, non-limiting examples, parallel lists may be used for paging record list information, paging group list information, inter-frequency carrier list information, application layer measurement information, session ID list information, etc. Other examples are also provided in 3GPP TS 38.331.

FIG. 3C illustrates one example of a parallel list for band combination configuration information. The band combination configuration information may be transmitted between a UE and base station, as illustrated and described with reference to FIG. 3B, or between other devices, such as between UEs and/or base stations, as also described with reference to FIG. 3B.

In FIG. 3C, a parallel list is shown for band combination configuration information in diagram 392 that includes a base or master list including band combination configuration information for a base release (e.g., Release 15) and a plurality of lists (e.g., extension lists) including band combination configuration information for various releases (e.g., Release 15.4, 15.5, etc.). Each extension list may include corresponding elements for each element in the master list, that is elements 1 through the ending element index of maxBandComb, which may be an integer value of up to 65,536.

However, as illustrated and described with reference to FIG. 3A, each extension list may only include active information for a few or subset of those many elements and the other elements may be absent. Because the elements are absent, as opposed to not included, each of the absent elements of the lists may have a corresponding indication or signaling overhead, which leads to increased signaling overhead and waste. This problem only gets larger as additional releases are added and/or as additional band combinations are added.

Diagram 394 illustrates an exemplary layout or configuration of the base or master list, BandCombination, and Diagram 396 illustrates an exemplary layout or configuration of one particular extension list, BandCombination-v1610. In diagram 394, the BandCombination includes one or more parameters or fields for each element (e.g., 1-maxBandComb) of the base list, here band list information (bandList), feature combination information, carrier aggregation parameter information, multi-RAT dual connectivity information, supported band combination information, and power class information.

In diagram 394, the BandCombination-v1610 includes one or more parameters or fields for each element (e.g., 1-maxBandComb) of the base list, here band list information (bandList), feature combination information, carrier aggregation parameter information, multi-RAT dual connective information, supported band combination information, and power class information. However, the actual number of included active or relevant elements for the extension list of BandCombination-v1610 may be small.

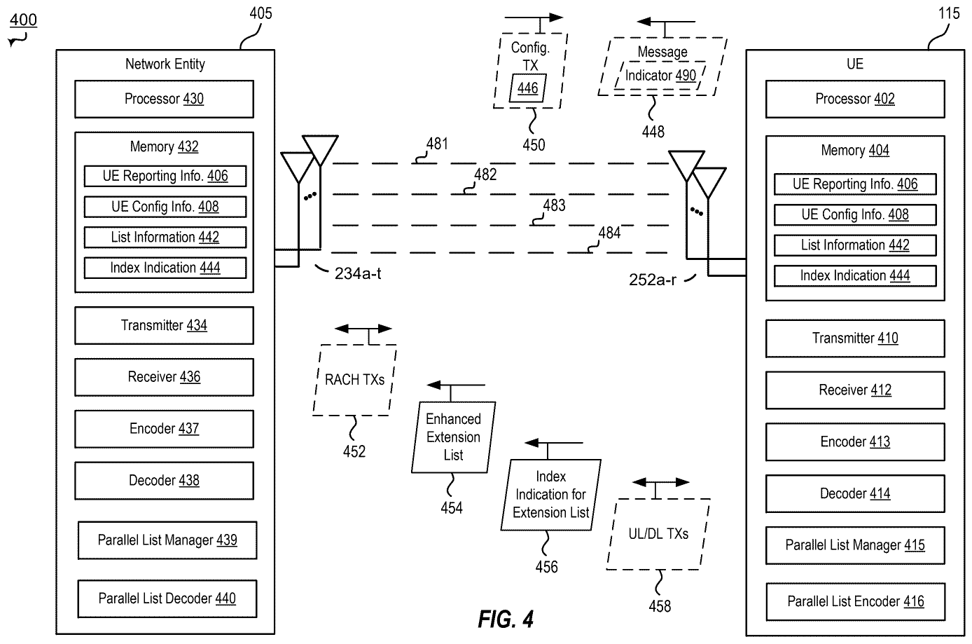

FIG. 4 illustrates an example of a wireless communications system 400 that supports enhanced coding operations for parallel lists in accordance with aspects of the present disclosure. In some examples, wireless communications system 400 may implement aspects of wireless communication system 100. For example, wireless communications system 400 may include a network, such as one or more network entities (e.g., network entity 405), and one or more UEs, such as UE 115. As illustrated in the example of FIG. 4, the network entity 405 may include or correspond to a base station, such as base station 105. Alternatively, a network entity may include or correspond to a different network device (e.g., not a base station). Enhanced coding operations for parallel lists improve coding efficiency (e.g., using reduced bits/bandwidth for transmitting the same data) for variable size parallel lists which may reduce bandwidth usage, latency, power consumption, and network overhead for communicating configuration and/or reporting information. These improvements enhance the overall performance of the wireless communications system 400 and the experience of the user.

Network entity 405 and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via network entity 405 and UE 115. For example, the control information may be communicated using MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, parallel list manager 415, parallel list encoder 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store UE reporting information 406, UE configuration information 408, list information 442, index indication information 444, settings data 446, or a combination thereof, as further described herein.

The UE reporting information 406 includes or corresponds to data that is associated with the UE 115 reporting information to the network or receiving report information from the network for the UE 115. As illustrative, non-limiting examples, the UE reporting information 406 may include power headroom reporting information, beam reporting information, failure reporting information, signal strength reporting information, signal quality reporting information, interference reporting information, latency/timing reporting information, etc. The UE reporting information 406 may be generated based on measurement information generated by the UE 115 or received by the UE 115.

The UE configuration information 408 includes or corresponds to data associated with or corresponding to configuration information for UE operations, such as, but not limited to UE capability information, RRC configuration information, etc. For example, the UE configuration information 408 may indicate UE capability information for carrier aggregation operations, multi-RAT dual connectivity operations, frequency band information, beamforming operations, etc. As an illustrative, non-limiting example, the UE configuration information 408 includes or corresponds to UE capability information for frequency band operations, such band combination configuration information (e.g., BandCombinationList IE).

The list information 442 includes or corresponds to data associated with or corresponding to one or more encoded sets of lists in a parallel format as described herein. For example, the list information 442 may include or correspond to encoded list data that has been encoded based on one or more of the enhanced encoded parallel list techniques described herein. The encoded list data for one set of lists may include encoded base list data and encoded extension list data (encoded parallel list data). The encoded extension list data may include encoded data for one or more extension lists of the particular set of lists. The list information 442 may include or be associated with index indication information 444 to enable indication of the elements present or absent in one or more lists (e.g., extension lists) of the list, and thus the list information 442 may be encoded to include a variable size parallel (i.e. extension) list where one or more elements of at least one parallel list of the set lists are omitted (not just absent) from the parallel list and from the signaling overhead. As illustrative examples, the UE reporting information 406 (or a portion thereof) and/or the UE configuration information 408 (or a portion thereof) may be encoded using an enhanced encoded parallel list technique (e.g., a starting index indication technique of settings data 446) to generate list information 442 and corresponding index indication information 444 that enables an encoder or decoder to correctly encode/parse a parallel list with omitted elements for/from one or more of the lists of the set of lists.

The index indication information 444 includes or corresponds to data associated with or corresponding to element indication information for the lists (e.g., extension lists) of the set of lists in parallel format described herein. For example, the index indication information 444 may indicate which elements are present or absent from a parallel/extension list of a set of lists in parallel format by indicating one or more indexes of the list. The particular index indication information 444 may be generated and decoded based on the particular enhanced coding scheme described herein, (e.g., a starting index indication scheme, an ending index indication scheme, a range index indication scheme, etc.). The indicated one or more indexes of the list enable identification of the specific elements included in a variable size list of the set of lists such that the not present elements may be omitted from the coding and signaling overhead.

The settings data 446 includes or corresponds to data associated with enhanced parallel list encoding operations. The settings data 446 may include one or more types of enhanced parallel list encoding operation modes and/or thresholds or conditions for switching between enhanced parallel list encoding operation modes and/or configurations. For example, the settings data 446 may have configuration data for encoding and decoding different types of parallel lists or information for parallel lists, such as starting index indication, ending indication, range indication, all element indication, reporting information configuration, configuration information configuration, capability information configurations, etc. As another example, the settings data 446 may have data indicating different thresholds for different enhanced parallel list encoding operation, such as for different amount of elements not included or included for different types of indication schemes (e.g., starting index indication, ending index indication, etc.).

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. The parallel list manager 415 may be configured to identify and perform enhanced parallel list encoding operations, such as parallel list encoding management operations to support enhanced parallel list encoding operations. For example, the parallel list manager 415 is configured to perform parallel list encoding mode identification and/or selection operations, index indication distribution identification and/or selection operations, enhanced parallel list encoding viability identification operations, or a combination thereof.

The parallel list encoder 416 may be configured to identify and perform enhanced parallel list encoding operations. For example, the parallel list encoder 416 may include or correspond to an enhanced ASN.1 encoder and may be configured to implement an encoding scheme selected or identified by the parallel list manager 415 (or the parallel list manager 439) and to encode the UE reporting information 406 or the UE configuration information 408 based on the selected scheme to generate encoded parallel list data, the list information 442. The parallel list encoder 416 may be configured to encode variable size lists in a parallel list format and indicate the omitted elements to reduce the signaling overhead for parallel lists. As one illustration, the parallel list encoder 416 may employ starting index indication encoding on the source data to encode the data and generate the enhanced list information 442 and corresponding index indication information 444 for the parallel list information indication the presence of elements in at least one list of the list information 442. The list information 442 generated by the parallel list encoder 416 may include variable size lists and omitted elements to reduce the signaling overhead.

Network entity 405 (e.g., base station 105) includes processor 430, memory 432, transmitter 434, receiver 436, encoder 437, decoder 438, parallel list manager 439, parallel list decoder 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store UE reporting information 406, UE configuration information 408, list information 442, index indication information 444, settings data 446, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. Parallel list manager 339 may include similar functionality as described with reference to parallel list manager 415. Parallel list decoder 440 may include similar functionality as described with reference to parallel list encoder 416. For example, parallel list decoder 440 and/or parallel list encoder 416 may include or correspond to a parallel list coder that is configured to perform enhanced parallel list encoding and decoding operations.

The parallel list decoder 440 may be configured to identify and perform enhanced parallel list decoding operations. For example, the parallel list decoder 440 may include or correspond to an enhanced ASN.1 decoder and may be configured to implement an decoding scheme selected or identified by the parallel list manager 439 (or the parallel list manager 415) and to decode the encoded parallel list data (e.g., a portion of the list information 442) using the index indication information 444 and based on the selected scheme to generate the UE reporting information 406 or the UE configuration information 408. As one illustration, the parallel list decoder 440 may employ starting index indication information to identify element in the encoded parallel list data and then decode (e.g., parse) the encoded parallel list data identify or retrieve the encoded UE reporting information 406 or UE configuration information 408 within. The parallel list decoder 440 may be configured to decode variable size lists and identify the omitted elements to reduce the signaling overhead.

During operation of wireless communications system 400, network entity 405 may identify that UE 115 has enhanced parallel list coding capabilities, such as enhanced parallel list coding capabilities for variable size extension list encoding and index indication. For example, UE 115 may transmit a message 448 that includes an enhanced parallel list coding configuration indication, indicator 490. Indicator 490 may indicate enhanced parallel list coding capabilities for all information or a particular type of information or mode of communication. In some implementations, network entity 405 sends control information to indicate to UE 115 that enhanced parallel list coding operations are to be used. For example, in some implementations, message 448 (or another message, such as configuration transmission 450) is transmitted by the network entity 405. The configuration transmission 450 may include or indicate to use enhanced parallel list coding operations or to adjust or implement a setting of a particular type of enhanced parallel list coding. In some aspects, the message 448 or the configuration transmission 450 includes the settings data 446 for enhanced parallel list coding operations and the settings data 446 indicates the type of enhanced parallel list coding to use and/or the distribution method for the index indication information.

During enhanced parallel list coding operation, devices of wireless communications system 400 perform one or more transmissions that include parallel list information that has been encoded according to an enhanced technique as described herein and where the devices also provide index indication information for the parallel list information that indicates or identifies the elements included in or omitted from one or more parallel lists of a set of lists in parallel format. For example, the UE 115 may transmit an enhanced parallel list with variable size lists (e.g., lists with an amount of elements that differs from other lists and/or a header indication) to the base station 105 in some aspects as illustrated in FIG. 4.

In FIG. 4, the network and the UE 115 may perform a RACH operation including one or more RACH transmissions 452 to enable the UE 115 to connect to the network, such as transition to a RRC Connected mode. Based on being in or transitioning to the connected mode, the UE 115 may transmit an enhanced parallel list representing UE configuration information 408. For example, the UE 115 (e.g., the parallel list manager 415 thereof) may identify an enhanced parallel list encoding mode (e.g., starting index indication mode) and may generate first extension list information (e.g., a portion of list information 442) and corresponding first index indication information (e.g., a portion of index indication information 444) indicating a starting index of elements present in one or more extension lists (e.g., enhanced extension lists) of the set of lists indicated by the first extension list information.

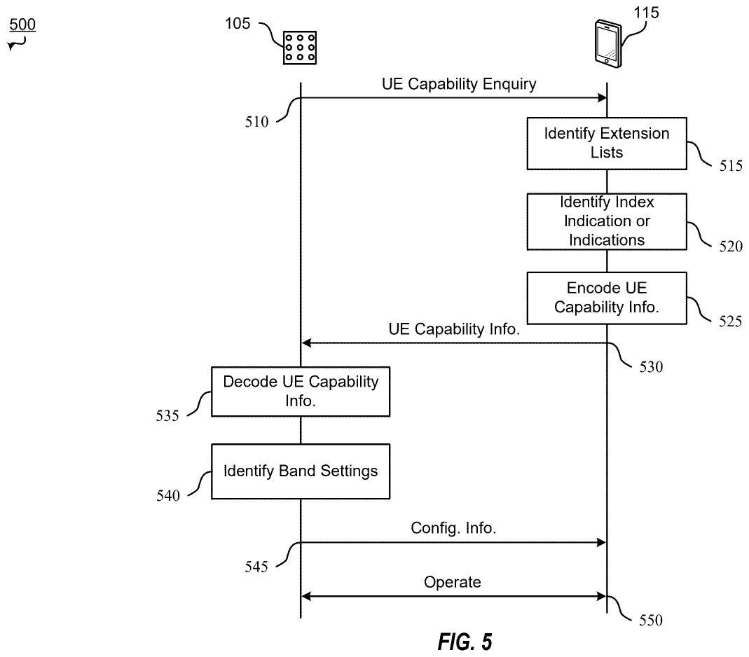

The UE 115 may then transmit the first extension list information in an enhanced extension list transmission 454 and the first index indication information in an index indication for the extension list transmission 456. As illustrated in FIG. 4, the transmissions 454 and 456 may be separate transmissions. Alternatively, the first extension list information and the corresponding first index indication information may be sent in the same transmission, such as in a same message or a different message of a single transmission. Examples of such transmission options are described further with reference to FIGS. 3A and 5-9C. As one illustrative example, the enhanced extension list transmission 454, the index indication for the extension list transmission 456, or both may include or correspond to a UE capabilities transmission, such as the UE capabilities information transmission at 530 of FIG. 5.

The base station 105 receives the first extension list information and the corresponding first index indication information and decodes the received information. For example, the parallel list manager 439 may identify or select a particular decoding scheme to use based on a configuration or based on an indication from the UE 115, and the parallel list decoder 440 may decode the first extension list information based on or using the corresponding first index indication information. To illustrate, the base station 105 may utilize the first index indication information to identify what elements have been omitted from one or more lists of the first extension list information. The base station 105 generates decoded UE configuration information (e.g., UE configuration information 408) based on decoding the first extension list information.

After decoding, the base station 105 may utilize the decoded information to identify or select configuration or operating settings for the UE 115 and/or to identify downlink grants for the UE 115. The base station 105 may then schedule the UE 115 for uplink and/or downlink transmissions 458 based on the received UE configuration information 408 (e.g., UE capability information) for the UE 115.

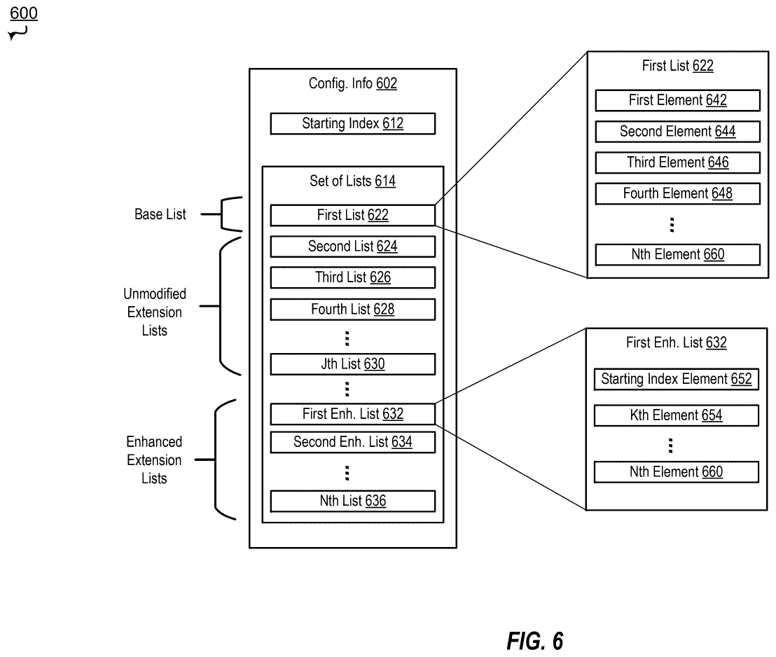

Additionally, or alternatively, the UE 115 may use enhanced encoding techniques for reporting information to the base station 105. For example, the UE 115 may generate measurement information from performing one or more UE measurement operations and may use a set of lists in parallel format to report the measurement information to the network. The UE 115 may generate second extension information similar to the first extension list information and representing the UE reporting information 406. The UE 115 may transmit the second extension list information and corresponding second index indication information to the network together or separately, and the second extension list information may be encoded using a different technique than the first extension list information (e.g., a range indication, an all element indication, etc.), examples of which are described further with reference to FIGS. 6-9C. The base station 105 may decode the received second extension list information using the second index indication information and may then change the operating parameters or generate additional UL and/or DL grants based on the decoded reporting information for the UE 115.

Accordingly, the UE 115 and network entity 405 may be able to more efficiently encode variable size lists of a set of lists in parallel format to reduce the size of the set of lists by reducing the size of at least one extension list thereof by omitting absent elements from at least one extension list thereof and by indicating the absent elements by a corresponding index indication. The communication of the more efficiently encoded (smaller/reduced size) parallel lists requires less bits and consumes less network overhead and power. Thus, FIG. 4 describes enhanced coding operations for parallel lists and performing the enhanced coding operations enables reduced network overhead and signaling and thus, enhanced UE and network performance by increasing throughput and reducing latency for other devices and the network as a whole.

Referring to FIG. 5, FIG. 5 is a timing diagram 500 illustrating a wireless communication system that supports enhanced parallel list coding operations according to one or more aspects. The example of FIG. 5 corresponds to an example of enhanced encoding of a parallel list for UE capability information, such as band combination information, as part of a UE capability enquiry exchange.

The example of FIG. 5 includes similar devices to the devices described in FIGS. 1, 2, and 4, such as a UE 115 and a network entity 405 (e.g., base station 105). The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, the network entity may include or correspond to multiple TRPs of a single base station (e.g., base station 105), to multiple base stations, or any combination thereof.

Prior to 510, the base station 105 and the UE 115 establish a Uu communication link (also referred to as Uu link or UL/DL link). For example, the UE 115 may perform RRC, RACH, and/or connection establishment operations to establish (or re-establish) an uplink and downlink communication link with a node of a network, such as base station 105. In some implementations, the communication link may be established as part of a handover operation or through another UE. In some aspects, the base station 105 and UE 115 may communicate higher layer signaling, such as RRC signaling (e.g., a RRC transmission or message) or control layer signaling, to establish the connection and link. After establishing the Uu communication link, the base station 105 and the UE 115 may communicate or exchange transmissions. For example, the UE 115 may receive downlink transmissions from the base station 105 and/or transmit uplink transmissions to the base station 105, such as to communicate data.

At 510, the base station 105 transmits a UE capability enquiry message to the UE 115. For example, the base station 105 may transmit a UE capability enquiry transmission to the UE 115 to request UE capabilities responsive to the UE 115 connecting to the base station 105 (e.g., transitioning to RRC Connected Mode). The UE capability enquiry transmission may include or correspond to a unicast transmission or a broadcast transmission. For example, the UE capability enquiry transmission may include or correspond to a unicast DL transmission, such as PDCCH, PDSCH or MAC CE, that includes the UE capability enquiry information for the UE 115.

At 515, the UE 115 identifies one or more variable size lists or extension lists for a set of lists of the UE capability information. For example, the UE 115 may identify a set of lists to report responsive to receiving the UE capability enquiry and that one or more extension lists of the set of lists have absent elements based on UE capabilities or configurations. As an illustrative, non-limiting example, the UE 115 may determine that for certain releases (e.g., Release 16.3) elements of a corresponding extension list for the release or releases is/are absent (e.g., not applicable, not configured, not capable, etc.) and would be signaled with a negative indication (e.g., bit with a value of zero).

In some aspects, if such variable size extension lists are present, the UE 115 may further identify if encoding the number of missing or absent elements with a particular enhanced encoding format (e.g., with index indication information) or with a conventional format (e.g., without index indication information) would reduce signaling overhead for the set of lists. For example, if the number of missing or omitted elements is larger than the overhead needed to signal index indication information, the UE 115 may identify to use an enhanced encoding method for the extension list of the set of lists or for the set of lists itself. If not, the UE 115 may refrain from using an enhanced encoding method as the index indication information signaling and overhead may take up more space than is reduced by the omission of absent elements for certain extension lists and/or the set of lists itself.

In some aspects, the UE 115 may identify which enhanced encoding method of a plurality of enhanced encoding methods may offer the best performance or may satisfy a threshold performance condition (e.g., number of bits saved, percentage reduction, etc.) prior to or in conjunction with identifying the extension lists or variable lists to provide index indication information for. For example, the UE 115 may identify whether a starting index type indication or a range index type indication may offer the best reduction in size for the set of lists and identify to use the particular index indication based on the identification.

At 520, the UE 115 identifies an index indication or indications for the extension list(s) of the set of lists for the UE capability information. For example, the UE 115 may identify a starting index indication or indications for one or more variable or extension lists of the sets of lists in parallel format responsive to identifying to engage in enhanced encoding operations for the sets of lists, such as based on the identification at 515. The index indications may be used to indicate or identify which elements are actually present or being signaled in the encoded extension list and which elements have been excluded/omitted and not encoded. Specific index indication examples are further illustrated and described with reference to FIGS. 6-9C.

At 525, the UE 115 encodes the UE capability information. For example, the UE 115 may encode the UE capability information using ANS.1 coding (e.g., by an ANS.1 encoder) based on the identified extension list(s), the starting indication(s), or a combination thereof. As an illustrative, non-limiting example the UE 115 may encode the band combination configuration information of the UE capability information to generate encoded band combination configuration information that represents a variable size parallel list with lists of various sizes and having omitted elements to reduce signaling overhead. Examples of encoded configuration information, such as encoded band combination configuration information are illustrated and described further with reference to FIGS. 6-9C.

At 530, the UE 115 transmits the encoded UE capability information to the base station 105 responsive to the UE capability enquiry message at 510. For example, the UE 115 may transmit the encoded UE capability information in a UE capability information message or transmission. The encoded UE capability information indicates settings and configurations that the UE is capable of performing and instructs the network on how to schedule and/or interact with the UE 115, and because the UE capability information was encoded with an enhanced encoding technique for variable size parallel lists, the UE capability information conveys the same capability information with less bits as compared to conventional methods (e.g., conventional ANS.1 encoding for parallel lists).

At 535, the base station 105 decodes the received encoded UE capability information to generate decoded UE capability information. For example, the base station 105 may identify the starting index indication or indications for one or more extension lists of the set of lists and may decode (parse) the one or more extension lists based on the starting indication or indications. To illustrate, the base station 105 may identify that the second list (e.g., first enhanced extension list) starts on element index 99 as opposed to element index 0 based a first starting index indication for the second list and that the third list (e.g., second enhanced extension list) starts on element index 127 as opposed to element index 0 or 99 based on a second starting index indication for the third list.

At 540, the base station 105 identifies a UE capability based on the decoded UE capability information. For example, the base station 105 may identify one or more band combination configurations for the UE 115 based on the decoded UE capability information. The base station 105 may generate configuration information and/or grants for the communication link between the base station 105 and UE 115 based on the decoded UE capability information.

At 545, the base station 105 may transmit the configuration information (and/or grant information) to the UE 115. For example, the base station 105 may transmit a RRC configuration transmission or grant transmission to the UE 115 indicating a particular operational configuration based on the decoded UE capability information. To illustrate, the base station 105 may transmit (e.g., broadcast) one or more RRC transmission and/or may transmit (e.g., unicast) one or more scheduling transmissions (e.g., PDCCH or DCI) including the configuration information.

At 550, the base station 105 and the UE 115 operate in accordance with the configuration information. For example, the station 105 and the UE 115 may communicate transmission based on the UE capability information which was encoded using enhanced encoding techniques for variable size lists. To illustrate, the UE 115 may operate in a DC mode or an inter-RAT DC mode and may transmit and receive transmissions from one or more base stations, including the base station 105, using a configuration/capability signaled in the UE capability information sent to the base station 105.

Although the example of FIG. 5 was described with reference to example for using enhanced parallel list encoding for UE configuration information in response to a capability enquiry from a network, in other examples the enhanced encoding methods for variable size parallel lists may be used for transmissions between UEs, transmission between base stations, or both. Additionally, or alternatively, although the example of FIG. 5 was described with reference to a parallel list of UE capability information (e.g., band combination configuration information), in other examples the enhanced encoding methods described herein can be applied to other variable sized parallel lists.

FIG. 6 is a block diagram 600 illustrating configuration information 602 including a set of lists 614 and index indication information that has been encoded by an enhanced technique according to one or more aspects. The set of lists 614 may include or corresponds to a set of parallel lists or a list (e.g., base list) with extensions (e.g., extension lists). The example of FIG. 6 corresponds to an example where the index indication information corresponds to a starting index indication. In other examples, other types of index indications may be used in addition to or in the alternative to the starting index indication, such as range indication, all element indications, etc.

In the example of FIG. 6, the configuration information 602 includes a starting index indication of a starting index 612 for a corresponding set of lists 614. The starting index 612 may include a single starting index for one or more lists of the set of lists 614 in some aspects. To illustrate, the starting index 612 may indicate a single starting index value that may be applied to one or more extension lists of the set of lists 614. In other aspects, the starting index 612 may include multiple starting indexes for multiple lists of the set of lists 614, where each extension list (e.g., enhanced extension list) has one or more starting index indications. To illustrate, a first starting index for a first extension list and a second starting index for a second extension list that may be different from the first starting index.

The starting index 612 may include or correspond to a field that indicates the presence or absence of elements of a list of the set of lists 614. Although referred to as a starting index, such as a starting index (e.g., starting element) for elements that are included or elements that are excluded, the starting index 612 may indicate an ending index (e.g., ending element) for elements that are included or elements that are excluded.

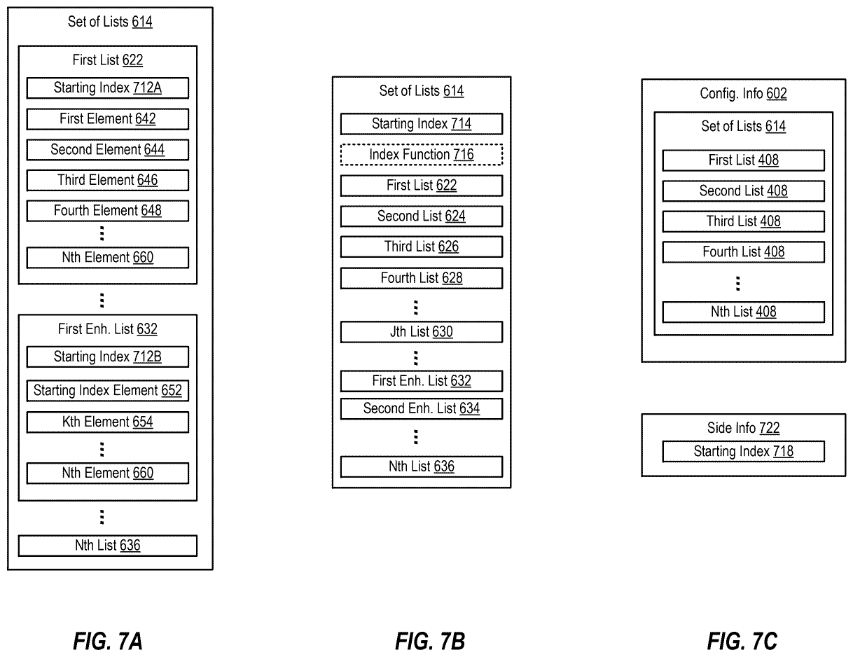

As shown in the example of FIG. 6, the starting index indication of the starting index 612 is included in the configuration information 602 and with the set of lists 614. In other examples, the index indication (e.g., the starting index 612) is communicated separately from the set of lists 614, such as outside of the configuration information 602. For example, the starting index indication for the set of lists 614 may be sent in another message, or in another transmission. When the starting index indication for the set of lists 614 is sent with the set of lists 614 (e.g., included in the configuration information 602), the starting index indication may be sent inside the set of lists 614 or outside of the set of lists 614, and when sent inside or with the set of lists 614, the starting index indication can be provided at one more layers of the set of lists 614. For example, the index indication for each list can be included in the list of the set of lists 614 (as in FIGS. 7A and 7B) or it can be separate from the list of the set of lists 614 (as in FIG. 7C).

The set of lists 614 includes or corresponds to a set of a plurality of lists that includes a base list, one or more non-variable size extension lists of the base list, and one or more variable size extension lists of the base list. The set of lists 614 may be referred to as a set of variable size parallel lists as described herein. The set of lists 614 includes a plurality of lists where at least one or more of the lists have a different amount of configured, active, present, or non-redundant elements. The encoded structure or base encoding of the set of lists 614 may utilize a format where each extension list of the set of lists 614 is encoded to have a same amount of elements as the base list no matter the amount of configured, active, present, or redundant elements in each list in order to reduce signaling overhead. However, as the number of lists and numbers of elements get larger, this format can result in a large signaling overhead from actively signaling absent elements.

In the example of FIG. 6, the set of lists 614 includes one or more extension lists which have a particular (e.g., maximum) amount of elements or a same number of elements as the base list, and one or more extension lists which have a reduced number of elements as compared to the base list. These extension lists may be referred to as enhanced extension lists or modified extension lists and contain a reduced number of elements as compared to the base list or lists. As illustrated in the example of FIG. 6, the set of lists 614 includes a first list 622, a second list 624, a third list 626, a furth list 628, a Jth list 630, a first enhanced list 632, a second enhanced list 634, and an Nth list 636. The first list may correspond a base list which does not have a starting index indication and for which does not have reduced elements. As an illustrative example, the first list 622 is a base list and has N elements, and the elements include a first element 642, a second element 644, a third element 646, a fourth element 548, etc., and an Nth element 660.

The second through Jth lists may correspond to normal (e.g., unmodified or unenhanced) extension lists which also do not have a starting index indication and for which do not have reduced elements. The second through Jth lists have the exact same elements as the first list 622 (base list) and in the exact same order.

The first enhanced list through the Nth list may correspond to enhanced or modified extension lists which have or share a corresponding starting index indication and which have reduced elements as compared to the normal, unmodified or base list and unmodified extension list(s) (e.g., the first through Jth lists). As an illustrative example, the first enhanced list 632 has less than N elements, and the elements include a staring index element 652, a Kth element 644, etc., and the Nth element 660. In the example of FIG. 6, the first enhanced list 632 has a format where the starting index indication indicates a starting index for elements which are present (as well as ending index of elements which are not present), such as the staring index element 652 through the Nth element 660.

In some aspects, each enhanced extension list has the same format as the first enhanced list 632. For example, each extension list after the first enhanced list 632 or each list indicated or identified as an enhanced extension list may include the same elements as the first enhanced list 632. To illustrate, when the starting index 612 includes a single starting index indication, the single starting index indication may be applied to each extension list that follows the identified first enhanced list (e.g., first enhanced list 632) or to each extension list indicated in the starting index 612 if the starting index 612 is a complex field that indicates a single starting index element and one or more enhanced extension lists associated with the single starting index element.

In some other aspects, multiple enhanced extension list formats may coexist in a single set of lists. For example, the second enhanced list 634 may include different elements from the first enhanced list 632 and optionally, the second enhanced list 634 may include fewer or greater total element as compared to the first enhanced list 632. To illustrate, the starting index indication may be a complex field indicating a different starting element for one or more enhanced extension lists of the set of lists 614 and thus the second enhanced list 634 may start at an Ith element or an Lth element as compared to the Kth element of the first enhanced list 632.

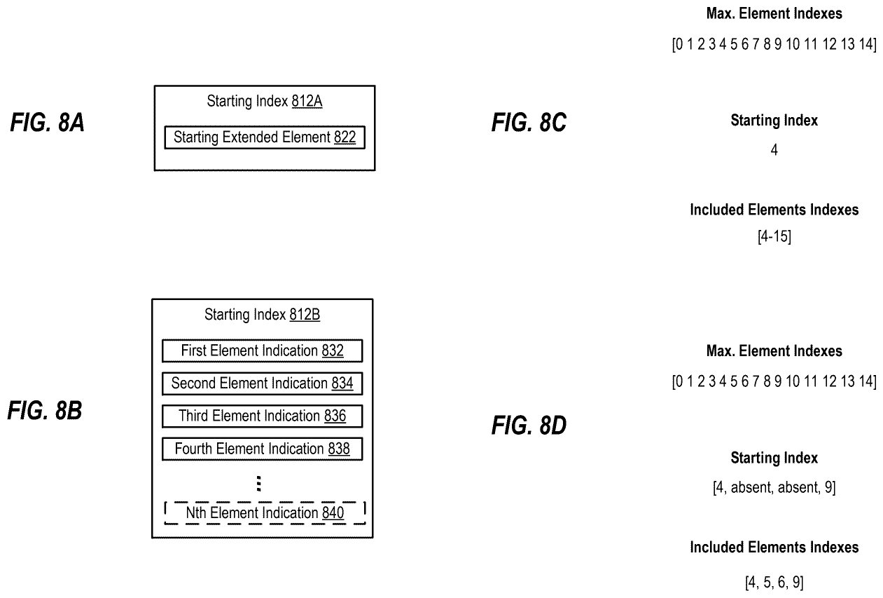

Although a simple starting index indication is illustrated in the example of FIG. 6, other element indication indications of the element that are present and/or absent from the extension list may be used in other examples. As one illustrative, non-limiting example, the starting index indication may be an included (or excluded) element range indication in some aspects as described with reference to FIGS. 7-8D. To illustrate, the starting index indication field may be replaced with or correspond to a range indication field that indicates two values which are parsed or interpreted as range of values to include or exclude. With respect to the example of FIG. 6, when a range indication field is used an extension list may include Ith through Kth elements (or exclude Ith through Kth elements) when the starting index indication field indicates an Ith value and Kth value) for one or more lists of the set of lists 614.

As another illustrative, non-limiting example, the starting index indication may be a complex indication for multiple ranges and indications in some aspects. To illustrate, the index indication field may indicate two values which are parsed or interpreted as range of values to include or exclude as described with reference to FIGS. 7-8D. With respect to the example of FIG. 6, when a range indication is used an extension list may include Ith through Kth elements (or exclude Ith through Kth elements) when the index indication field indicates an Ith value and Kth value) for one or more lists of the set of lists 614.

As yet another illustrative, non-limiting example, the starting index indication may be an included (or excluded) element index list in some aspects. To illustrate, the index indication field may indicate each element that is included or excluded, as described with reference to FIGS. 7-8D. With respect to the example of FIG. 6, when a list of elements is used for an extension list, the extension list may include or exclude each item listed in the index field, such as only the 4^{th}, 7^{th}, and 9^{th}, elements when the index indication field includes a list of 3 values of 4, 7, and 9 (or their binary equivalents of 3, 6, and 8 when starting from a zero index).

Although the set of lists 614 in the example in FIG. 6 has a format where the 614 has multiple base or unmodified length extension lists with each element and multiple enhanced extension lists grouped together, in other examples the two types of extension lists may be in any order. Alternatively, in some aspects the set of lists 614 may not include any base or unmodified length extension lists with the maximum number of elements and each extension list of the set of lists 614 may be an enhanced or modified extension list with one or more omitted elements.

FIGS. 7A-7C are each a block diagram 700 illustrating an example of the starting indication and set of lists of FIG. 6. In FIGS. 7A-7C, different schemes are shown for signaling and transmitting the starting index indication for set of lists. As illustrative, non-limiting examples, the starting index indication is included in the set of lists, as in FIGS. 7A and 7B, or sent separately from the set of lists in FIG. 7C. When sent in the set of lists, the starting index inflation can be separate from the extension lists as in FIG. 7A, or with the corresponding extension list as in FIG. 7B.

FIG. 7A is a block diagram 700 illustrating an example of the set of lists 614 of FIG. 6. In the example of FIG. 7A, the starting index indication is included with the corresponding extension list and is at the element level. To illustrate, the encoding and structure of the set of lists 614 may be such that the corresponding starting index indication for each extension list is encoded in or with the extension list itself. The index indication field, here a starting index field, may be a mandatory field or an optional field. When a mandatory field, the field is always included and the starting index field may indicate a value or values of elements which are present or not for the list or a null value that indicates all elements are present and the starting index indication is not used (e.g., for a full element extension list or non-modified extension list). When optional, the starting index field may be present in only some extension lists when an indicator flag indicates it as such. Thus, for full element extension lists or non-modified extension lists, the field may be absent, and the optional field configuration may reduce overhead as compared to the mandatory field configuration.

As illustrated in the example of FIG. 7A, two lists of the set of lists 614 are shown, a base list and an extension list. The first list 622 is the base list, and the first enhanced list 632 is the extension list of the base list. In the example of FIG. 7A, the first list 622 has a corresponding starting index field 712A and N elements, and the elements include a first element 642, a second element 644, a third element 646, a fourth element 548, etc., and an Nth element 660. The first enhanced list 632 has a corresponding starting index field 712B and has less than N elements, and the elements include a staring index element 652, a Kth element 644, etc., and the Nth element 660. For the first list 622, the starting index field 712A indicates the index of the first element 642 (e.g., 0) to indicate that all elements are present, i.e., the first element has an index of 0 and all elements after the starting index element (here the first element 642) are present. Similarly, for the first enhanced list 632 the starting index field 712B indicates the index of the starting index element 652 to indicate that the first element is the starting index element 652 and all elements after the starting index element 652 are present.

FIG. 7B is a block diagram 704 illustrating an example of the set of lists 614 of FIG. 6. In the example of FIG. 7B, the index indication is included with the set of lists 614 and is outside the extension lists or above the element level of the extension list. To illustrate, the encoding and structure of the set of lists 614 may be such that the index indication for one or more extension lists is encoded outside of or above the individual extension lists of the set of lists 614. The index indication, here a starting index field 714, may be a mandatory field or an optional field, as described with reference to FIG. 7A. By including an index indication at this level, the index indication may be more easily applied to more extension lists with less signaling overhead, such as compared to the embedded indication in each extension list in FIG. 7A (or each list, such as in the base list as well). However, the encoding and parsing of such an indication as in FIG. 7B may be more complicated than the example in FIG. 7A.

As described with reference to FIG. 6, the starting index field 714 may include multiple starting index indications for one or more extension lists of the set of lists 614. Thus, each of the (enhanced) extension lists with modified amounts of elements in the set of lists 614 may include different elements and/or different amounts of elements according to their different starting index indications.

In some examples, the set of lists 614 includes an optional index function field, such as index function 716. The index function 716 may be a field including a function or macro for implementing the starting index indication(s) of the starting index 714, such as when the index indication is included in the set of lists 614 but outside or above the extension lists or elements thereof themselves as in FIG. 7B, and as opposed to FIG. 7A. For example, the index function 716 may include or correspond to a parameterized type macro for one or more extension lists of the set of lists 614, such as for implementing the starting index indication for the corresponding lists set of lists 614. To illustrate, the index function 716 may jointly indicate with the starting index field 714 a starting index indication and extension list indication and may be used to signal new extension lists of the set of lists 614.

The index function 716 may be configured to apply the starting index indications indicated by the starting index field 714 to the extension lists. For example, when an extension list is present in the set of lists 614, the index function 716 is called and provides the starting index indication and the extension list identification for the set of lists 614. To illustrate, each list of the set of lists 614 or each extension list of the set of lists 614 may be encoded such that the index function 716 is called to apply the starting index indication corresponding to the particular list or extension list. The index function 716 may be similar in nature to the “SetupRelease” macro of 3GPP TS 38.331, which is a function call to release element type parameters.

FIG. 7C is a block diagram 706 illustrating an example of the set of lists 614 of FIG. 6. In the example of FIG. 7C, the index indication is sent outside of the set of lists 614 and as side information for the set of lists 614. To illustrate, the encoding and structure of the set of lists 614 may be such that the index indication for one or more extension lists thereof is encoded outside of the set of lists 614 itself.

As illustrated in the example of FIG. 7C, side information 712 includes a starting index indication, starting index indication field 718, and the side information 712 is separate from the configuration information 602. In some aspects, the side information 712 is sent separate from the configuration information 602, such as sent in a different message of the same transmission or a different transmission altogether. In some other aspects, the side information 712 is sent together with the configuration information 602, but in another information element of data structure, and may be encoded separately.

The starting index indication field 718 may include or correspond to the starting index indication field 714 of FIG. 7B. For example, as the starting index indication field 718 of FIG. 7C is outside of the particular corresponding extension list of the set of lists 614 (as in the example of FIG. 7A), the starting index indication field 718 may include a plurality of starting index indications for the lists of the set of lists 614 and may include starting (element) index indications associated with list index information. Additionally, similar to FIG. 7B, the side information 722 of FIG. 7C may optionally include function or macro information for processing the set of lists 614, similar to the index function field 716 of FIG. 7B.

For any of the options of FIGS. 6-7C when a starting index indication is provided without a macro or function call, the starting index indication may be a mandatory field or an optional field. For example, the RRC signaling protocol or specification may include a rule or guideline that all extension lists are to include an optional or mandatory element indication field (e.g., starting index indication field) that indicates which elements are and/or are not present in the extension list of the set of lists 614.

FIGS. 8A and 8B are block diagrams of example index indication fields for corresponding extension lists of a set of lists 614, and FIGS. 8C and 8D are diagrams of corresponding element indications for the corresponding extension lists of the set of lists 614 for the indications of the index indication fields of FIGS. 8A and 8B.

Referring to FIGS. 8A and 8C, in the example of FIG. 8A the index indication is a starting index field 812A that has a format of a starting extended element index indication 822 of a single integer value which indicates a starting element index in a corresponding extension list of a set of lists, such as the extension list in which the starting index field 812A is included within or linked to. The starting index field 812A of FIG. 8A indicates a starting index as illustrated in the example of FIG. 8C.

As illustrated in the example of FIG. 8C, a particular extension list that corresponds to the starting index indication of FIG. 8A has a maximum of 15 possible elements, such as 15 elements in the base, first, largest, master, or all lists of a set of lists in parallel format. When the starting index indication indicates a value of four (4) for the starting element index, the corresponding extension list includes element indices of the starting index (4) through the last index value (14 which represents the 15^{th} element in binary notation starting from 0 as the first element index). Thus, the particular extension list includes elements with indices 4-14 and omits elements with indices 0-3.

In other examples, the starting index indication may include multiple values to make more complex indications which omit more elements and is more flexible. For example, a range, multiple ranges, or even non-contiguous elements indices may be indicated by larger starting index fields with more values. As one illustration, a single range may be indicated by two values where a first value indicates a starting index and a last value indicates and ending index, such that the indication may allow only elements 4-9 to be included in the extension list and can omit the last 5 elements from the example in FIG. 8C. As another illustration, multiple ranges of elements to be included or excluded may be indicated by two or more values. For example, a first value may indicate a first set of included or excluded elements starting from a starting index and ending at the first value and a second value of may indicate a second set of included or excluded elements starting from the second value and ending at the ending index, such as to include (or excluded) elements 4-9 when values of 4 and 9 are signaled by the starting index indication field.

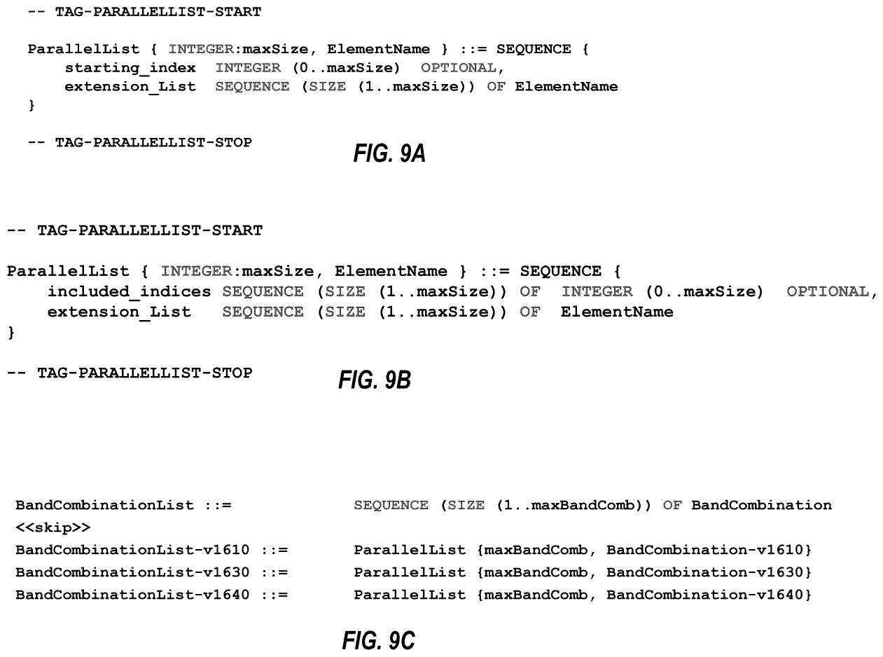

As yet another illustration, the starting index indication may include or correspond to an index for each element of the extension list to indicate a presence or absence of each element of the extension list, as described further in detail with reference to FIG. 9B. This would provide the greatest amount of overhead, that is more bits in the starting index indication, but provides the greatest amount of flexibility for including and omitting elements and may cause a large reduction in the overall size of the set of lists when a significant portion of the extension lists include few elements. Alternatively, the starting index indication may include other more complicated signaling schemes when the starting index indication includes multiple values as described further with reference to FIGS. 8B and 8D.

Referring to FIGS. 8B and 8D, in the example of FIG. 8B the index indication is a starting index field 812B that has a format of a multiple index indications and may include multiple integer values which indicate a presence or absence of elements in an extension list of a set of lists, such as the extension list in which the starting index field 812B is included within. For example and as illustrated in FIG. 8B, the starting index field 812B includes a first element indication 832, a second element indication 834, a third element indication 836, and a fourth element indication, etc., through an Nth element indication 840. The element indications may be indicated by integer values corresponding to their indexes. The starting index field 812B may optionally include fewer element indications or greater element indications, such as Nth element indications, in other examples. The starting index field 812B of FIG. 8B indicates included elements of an extension list as illustrated in the example of FIG. 8D.

As illustrated in the example of FIG. 8D, a particular extension list that corresponds to the starting index field 812B of FIG. 8B has a maximum of 15 possible elements, such as 15 elements in the base, first, largest, master, or all lists of a set of lists in parallel format. When the starting index field 812B includes four elements (first through fourth element indications 832-838) with corresponding values of four (4), absent (e.g., 0, null, or a reserved value), absent, and nine (9) for the starting element index, the corresponding extension list includes element indices of four (4), five (5), six (6), and nine (9). That is, the first value of the first element indication 832 indicates the starting index of four (4), and the last value of the fourth element indication 838 indicates an ending index of 9. The two absent indications of the second and third element indications 834, 836 indicate two omitted elements within the range between the starting index of 4 and the ending index of 9. In the example of FIG. 8D, the two absent indications of the second and third element indications 834, 836 indicate that the two omitted elements immediately precede the ending index of 9. Thus, the extension list includes elements with indices 4, 5, 6, and 9, as only indices 7 and 8 are omitted through the use of the two absent indications.

In other examples, the signaling scheme could omit values on the other end, the starting end, such as element indices 4 and 5, and include element indices 7 and 8. Similarly, if one less absent indication was included the included elements in the extension list would be 4-7 and 9 (or 4 and 6-9), while if one more absent indication was included the included elements in the extension list would be 4, 5, and 9 (or 4, 8, and 9). Thus, a mixture of range indications and element indices can be used in a more shorthand form to provide increased flexibility as opposed to single starting index indications or range indication and reduced overhead as compared to an entire index or explicit indication of the presence or absence of each element.

Although the elements of the enhanced extension lists of a set of lists in parallel format described in the above examples have been described generically or simply as being a single item, in the aspects described herein, the coding techniques can be applied to nested lists, including nested extension or parallel lists where a first extension list may have one or more second extension lists nested inside it. That is, one or more of the elements identified by the index indication as being included in a list of the first extension list, may indeed by an extension list itself and be one of the nested second extension lists. The enhanced coding techniques described herein can be applied at either level, such as to the first and/or second parallel lists. One example of an extension list that may include a nested list is an extension list for band combination information and is illustrated and described further with reference to FIGS. 9A-9C.

FIGS. 9A-9C are each a diagram illustrating an example of a function call or macro for a starting index indication of the set of lists 614 of FIG. 7B that includes an index function field. The function call or macro may include or correspond to the index function field 716 of FIG. 7B. The index function field 716 may include the index indication information and may also include extension list indication information to identify the corresponding extension list for the index indication information.

FIGS. 9A and 9B each illustrate a different type of function call or macro, and FIG. 9C illustrates an example parallel list where a function call or macro is performed for extension list(s) of the base (original) list. Specifically, FIG. 9A illustrates a parameterized type macro (called ParallelList for illustration) with a starting index indication type, and FIG. 9B illustrates a parameterized type macro (ParallelList) with an all index indication type. FIG. 9C illustrates an example of an illustrative format of a parallel list that is compatible with and written in terms of the parameterized type macro of FIG. 9A or FIG. 9B.

Referring to FIG. 9A, in the example of FIG. 9A the parameterized type macro (ParallelList) has a format of a starting index indication and corresponding extension list information such that the parameterized type macro can indicate a (single) starting index indication for each extension list of the set of lists. As illustrated in the example of FIG. 9A, the starting index indication is a simple starting index indication of a single element and is a single integer within the range of 0 to ending element (e.g., maxSize). In other examples, the starting index indication may be a complex starting index indication and may indicate a range or multiple ranges of included indices, as described above. Alternatively, the parameterized type macro may explicitly indicate the included or excluded indices as in FIG. 9B.

Referring to FIG. 9B, in the example of FIG. 9B the parameterized type macro (ParallelList) has a format of an included index indication and corresponding extension list information such that the parameterized type macro can indicate the included index indication for each extension list of the base or original list. As illustrated in the example of FIG. 9B, the included index indication is a sequence of integers with a length of the total number of elements (e.g., maxSize) where each integer included in the sequence indicates the index of the element that is present. Alternatively, in some other examples each index could be represented by a bit where a value of the bit may indicate a presence (or absence) of the index and element, such as by a value of 1 indicating present and a value of 0 indicating absent. In other words, the indexes of the included elements may be represented as a bitmap instead of a sequence of integers.

Referring to FIG. 9C, in the example of FIG. 9C an example parallel list which has a format where a function call or macro is made to a ParallelList macro, such as in FIG. 9A or FIG. 9B, for each extension list (e.g., BandCombiantionList-v1610) of the original list (BandCombinationList). In this way, the encoder and decoder will process each extension list of the original list based on the starting index indication of the function/macro of FIG. 9A or the included indices indication of the function/macro of FIG. 9B. As illustrated in the examples of FIGS. 9A-9C each extension list may have their own starting index indication or included indices indication by using a macro and including function calls for the lists in the set of lists.

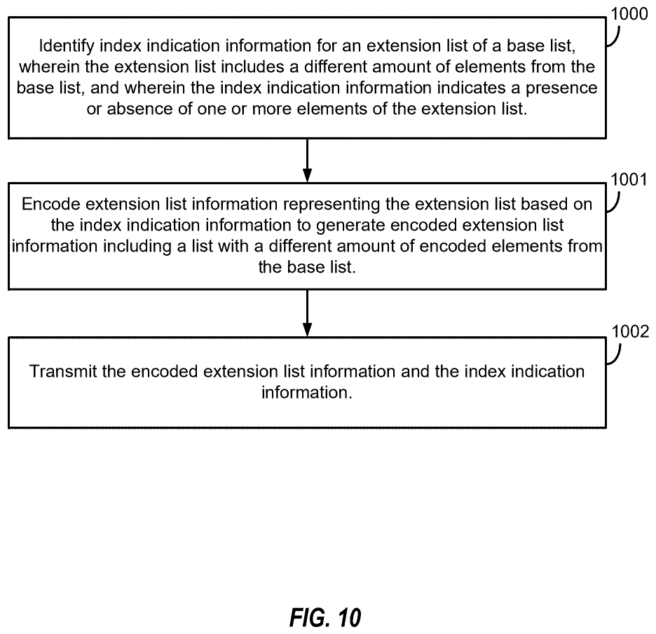

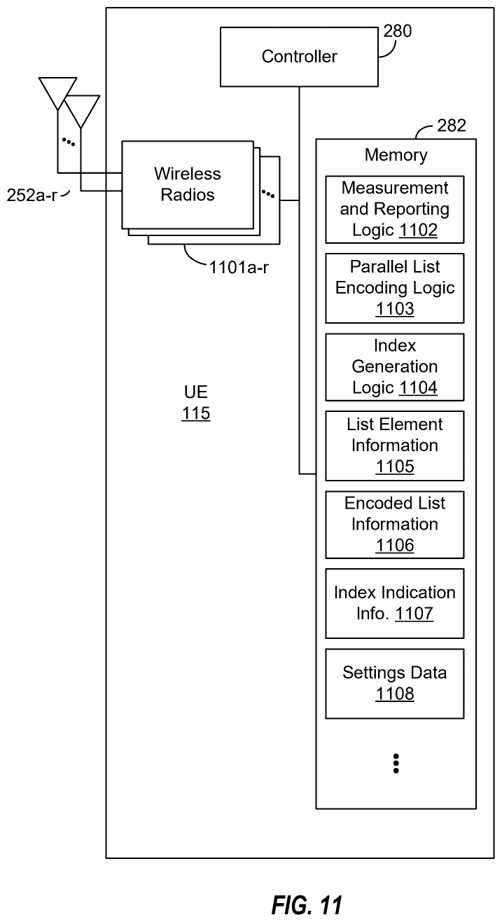

FIG. 10 is a flow diagram illustrating example blocks executed by a UE configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1100a-r and antennas 252a-r. Wireless radios 1100a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores measurement and reporting logic 1102, parallel list encoding logic 1103, index generating logic 1104, list element information 1105, encoded list information 1106, index indication information 1107, and settings data 1108.

At block 1000, a wireless communication device, such as a UE or base station, identifies index indication information for an extension list of a base list, wherein the extension list includes a different amount of elements from the base list, and wherein the index indication information indicates a presence or absence of one or more elements of the extension list. For example, the UE 115 identifies the index indication information 444 for at least one enhanced extension list of a base list of a set of lists, as described with reference to FIGS. 4-8B. The index indication information 444, such as portion of thereof, may be represented by an index field and/or index function field, as described with reference to FIGS. 6-8B, such as a starting index 612, 712A, 712B, 714, 718, and an index function field 716. The UE 115 may identify the index indication information 444 as described with reference to FIG. 5, and such may include evaluating the elements of the extension list for one or more parallel list encoding types or schemes.

At block 1001, the wireless communication device encodes extension list information representing the extension list based on the index indication information to generate encoded extension list information including a list with a different amount of encoded elements from the base list. For example, the UE 115 encodes unencoded list information for the extension list based on or using the index indication information 444 to generate a portion of the list information 442, such as encoded list information for the extension list of the set of lists, as described with reference to FIGS. 4-8B.

At block 1002, wireless communication device transmits the encoded extension list information and the index indication information. For example, the UE 115 transmits the enhanced extension list transmission 454, including the list information 442, and the index indication for the extension list transmission 456, including index indication information 444, as described with reference to FIGS. 4-8B.

The UE 115 may execute additional blocks (or the UE 115 may be configured further perform additional operations) in other implementations. For example, the UE 115 may perform one or more operations described above. As another example, the UE 115 may perform one or more aspects as described below.

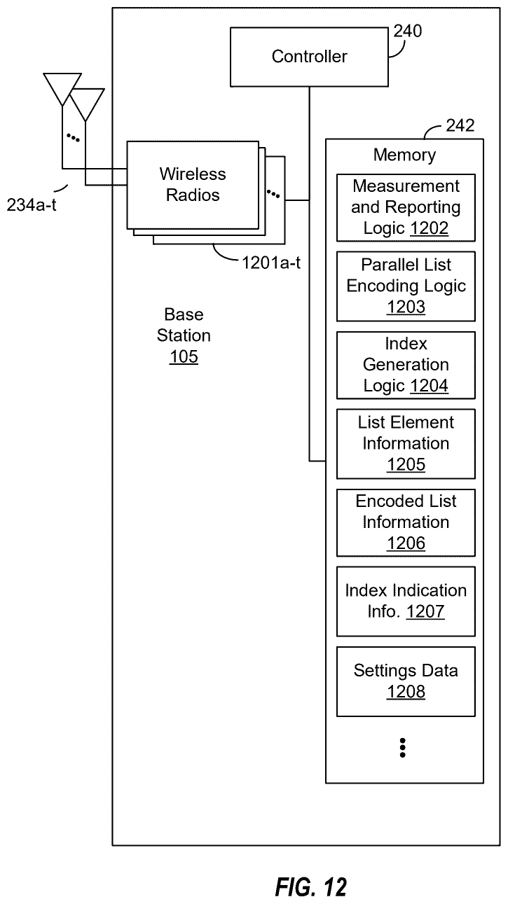

FIG. 12 is a block diagram illustrating base station 105 configured according to one aspect of the present disclosure. Base station 105 includes the structure, hardware, and components as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1201a-t and antennas 234a-t. Wireless radios 1201a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 12, memory 242 stores measurement and reporting logic 1202, parallel list encoding logic 1203, index generating logic 1204, list element information 1205, encoded list information 1206, index indication information 1207, and settings data 1208. One of more of 1202-1208 may include or correspond to one of 1102-1108.

In some aspects, the base station 105 may execute corresponding decoding blocks for the encoding blocks described in FIG. 10. Additionally, or alternatively, the base station 105 may execute the blocks of FIG. 10, and perform the actions ascribed to the UE 115 above, and the UE may execute corresponding decoding blocks. The base station 105 may execute additional blocks (or the base station 105 may be configured further perform additional operations) in other implementations. For example, the base station 105 may perform one or more operations described above. As another example, the base station 105 may perform one or more aspects as described below.

Accordingly, a UE and a base station may perform enhanced parallel list encoding operations. By performing enhanced parallel list encoding operations, devices of the wireless network may be able to more efficiently encode variable size lists of a set of lists in parallel format to reduce the size of the set of lists by reducing the size of at least one extension list thereof by omitting absent elements from the extension list(s) thereof and by indicating the absent elements by a corresponding index indication. The communication of the more efficiently encoded (e.g., smaller/reduced size) parallel lists requires less bits and consumes less network overhead and power. Thus, UE and network performance is enhanced by increasing throughput and reducing latency for other devices and the network as a whole.

In a first aspect, an apparatus for wireless communication includes a processing system including one or more processors and one or more memories coupled to the one or more processors. The processing system is configured to identify index indication information for an extension list of a base list, wherein the extension list includes a different amount of elements from the base list, and wherein the index indication information indicates a presence or absence of one or more elements of the extension list; encode extension list information representing the extension list based on the index indication information to generate encoded extension list information including a list with a different amount of encoded elements from the base list; and transmit the encoded extension list information and the index indication information.

In a second aspect, alone or in combination with one or more of the above aspects, the processing system is further configured to: identify an encoding mode for the extension list based on an encoded mode indication from the network, based on an evaluation of absent elements of the extension list, or both, wherein the index indication information is identified based on the encoding mode, and wherein the extension list information is further encoded based on the encoding mode.

In a third aspect, alone or in combination with one or more of the above aspects, the index indication information comprises a starting index indication. In some such aspects, the index indication information comprises a starting index indication in a first element of the extension list. In some other such aspects, subsequent elements after the starting index element are always present up to the end of the list

In a fourth aspect, alone or in combination with one or more of the above aspects, the index indication information comprises a range index indication.

In a fifth aspect, alone or in combination with one or more of the above aspects, the index indication information comprises a list of indices indication. In some such aspects, the list of indices indication is a list of indices that are included and comprises a sequence of integers which identify the indexes included in the list or a bitmap indicating the indexes included in the list.

In a sixth aspect, alone or in combination with one or more of the above aspects, the index indication information comprises a complex indication of one or more types of indications.

In a seventh aspect, alone or in combination with one or more of the above aspects, the at least one processor configured to cause the apparatus to transmit the encoded extension list information and the index indication information includes to: transmit the encoded extension list information and the index indication information in a same transmission.

In an eighth aspect, alone or in combination with one or more of the above aspects, the encoded extension list information is separate from the index indication information.

In a ninth aspect, alone or in combination with one or more of the above aspects, the encoded extension list information includes the index indication information.

In a tenth aspect, alone or in combination with one or more of the above aspects, the index indication information is included in the extension list as part of the elements of the encoded extension list information.

In an eleventh aspect, alone or in combination with one or more of the above aspects, the index indication information applies to one or more other extension lists that extend from the base list and is outside of the elements of the one or more other extension lists of the encoded extension list information.

In a twelfth aspect, alone or in combination with one or more of the above aspects, the processing system configured to transmit the encoded extension list information and the index indication information includes to: transmit the encoded extension list information in a first transmission; and transmit the index indication information as side information for the encoded extension list information in a second transmission separate from first transmission.

In a thirteenth aspect, alone or in combination with one or more of the above aspects, the index indication information is a mandatory field of the extension list information.

In a fourteenth aspect, alone or in combination with one or more of the above aspects, the index indication information is an optional field of the extension list information.

In a fifteenth aspect, alone or in combination with one or more of the above aspects, the index indication information is included in a macro or functional call of the extension list information, and wherein the extension list reference the macro or function call. In some such aspects, the macro or functional call indicates a starting index indication and includes extension list indication information. In some other aspects, the macro or functional call indicates a list of indices indication and includes extension list indication information.

In a sixteenth aspect, alone or in combination with one or more of the above aspects, the index indication information identifies omitted elements of the elements of the extension list which are not included (e.g., not actively signaled or represented by bits) in the encoded extension list information.

In a seventeenth aspect, alone or in combination with one or more of the above aspects, at least one element of the elements of the extension list corresponds to a second extension list that extends from a second base list, and wherein the second extension list is associated with second index indication information that indicates a presence or absence of one or more elements of the second extension list as compared to the second base list.

In an eighteenth aspect, alone or in combination with one or more of the above aspects, the processing system is further configured to: receive configuration information based on (e.g., generated based on) and responsive to the transmission of the encoded extension list information; and communicate based on the received configuration information.

In a nineteenth aspect, alone or in combination with one or more of the above aspects, the extension list information corresponds to UE capability information (e.g., band combination information).

In a twentieth aspect, alone or in combination with one or more of the above aspects, the processing system configured to encode the extension list information includes to: Abstract Syntax Notation One (ASN.1) encode the extension list information using one or more index indications of the indication index indication information to generate the encoded extension list information.

In another aspect, alone or in combination with one or more of the above aspects, the processing system configured to ASN.1 encode the extension list information using the one or more index indications includes to: identify a first subset of elements for the extension list to encode from a set of elements for the base list based on first index indications of the one or more index indications that corresponds to the extension list and based on a type of index indication; ASN.1 encode the first subset of elements of the extension list; identify a second subset of elements for a second extension list that extends from the base list to encode from a set of elements for the base list based on second index indications of the one or more index indications that corresponds to the second extension list and based on the type of index indication; and ASN.1 encode the second set of elements of the second extension list, wherein the first set of elements is larger or smaller than the second set of element.

In another aspect, alone or in combination with one or more of the above aspects, the processing system configured to ASN.1 encode the extension list information using the one or more index indications includes to: identify a first subset of elements for the extension list to encode from a set of elements for the base list based on first index indications of the one or more index indications that corresponds to the first list and based on a first type of index indication; ASN.1 encode the first subset of elements of the first list; identify a second subset of elements for a second extension list that extends from the base list to encode from the set of element for the base list based on second index indications of the one or more index indications that corresponds to the second extension list and based on a second type of index indication that is different form the first type of index indication; and ASN.1 encode the second set of elements of the second extension list, wherein the first set of elements is larger or smaller than the second set of elements.

In another aspect, alone or in combination with one or more of the above aspects, the apparatus is a user equipment (UE) or a base station, and wherein the encoded extension list information is transmitted to a second UE or a second base station.

In another aspect, alone or in combination with one or more of the above aspects, a RRC specification that controls the encoding includes a rule or guideline that that all extension lists shall include a mandatory or optional field for index indication information.

In another aspect, alone or in combination with one or more of the above aspects, the at least one processor is further configured cause the apparatus to identifya distribution mode for the index information, and wherein the index indication information is transmitted based on the distribution mode.

In an additional aspect, an apparatus for wireless communication comprises a processing system including one or more processors and one or more memories coupled to the one or more processors. The processing system is configured to: receive encoded extension list information, wherein the encoded extension list information indicates an extension list including a different amount of elements from a base list in which the extension list extends from; receive index indication information corresponding to the extension list and indicating a presence or absence of one or more elements of the extension list; decode the encoded extension list information based on the index indication information to generate extension list information; and operate/communicate based on the generated decoded extension list information.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-15 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication, comprising:
a processing system including one or more processors and one or more memories coupled to the one or more processors, the processing system configured to:
identify index indication information for an extension list of a base list, wherein the extension list includes a different amount of elements from the base list, and wherein the index indication information indicates a presence or absence of one or more elements of the extension list;
encode extension list information representing the extension list based on the index indication information to generate encoded extension list information including a list with a different amount of encoded elements from the base list; and
transmit the encoded extension list information and the index indication information.

2. The apparatus of claim 1, wherein the processing system is further configured to:
identify an encoding mode for the extension list based on an encoded mode indication from a network, based on an evaluation of absent elements of the extension list, or both, wherein the index indication information is identified based on the encoding mode, and wherein the extension list information is further encoded based on the encoding mode.

3. The apparatus of claim 1, wherein the index indication information comprises a starting index indication.

4. The apparatus of claim 1, wherein the index indication information comprises a range index indication.

5. The apparatus of claim 1, wherein the index indication information comprises a list of indices indication.

6. The apparatus of claim 1, wherein the index indication information comprises a complex indication of one or more types of indications.

7. The apparatus of claim 1, wherein the processing systemconfigured to transmit the encoded extension list information and the index indication information includes to:
transmit the encoded extension list information and the index indication information in a same transmission.

8. The apparatus of claim 7, wherein the encoded extension list information is separate from the index indication information.

9. The apparatus of claim 7, wherein the encoded extension list information includes the index indication information.

10. The apparatus of claim 9, wherein the index indication information is included in the extension list as part of the elements of the encoded extension list information.

11. The apparatus of claim 9, wherein the index indication information applies to one or more other extension lists that extend from the base list and is outside of the elements of the one or more other extension lists of the encoded extension list information.

12. The apparatus of claim 1, wherein the processing system configured to transmit the encoded extension list information and the index indication information includes to:
transmit the encoded extension list information in a first transmission; and
transmit the index indication information as side information for the encoded extension list information in a second transmission separate from first transmission.

13. The apparatus of claim 1, wherein the index indication information is a mandatory field of the extension list information.

14. The apparatus of claim 1, wherein the index indication information is an optional field of the extension list information.

15. The apparatus of claim 1, wherein the index indication information is included in a macro or functional call of the extension list information, and wherein the extension list reference the macro or function call.

16. The apparatus of claim 1, wherein the index indication information identifies omitted elements of the elements of the extension list which are not included in the encoded extension list information.

17. The apparatus of claim 1, wherein at least one element of the elements of the extension list corresponds to a second extension list that extends from a second base list, and wherein the second extension list is associated with second index indication information that indicates a presence or absence of one or more elements of the second extension list as compared to the second base list.

18. The apparatus of claim 1, wherein the processing system is further configured to:
receive configuration information based on and responsive to the transmission of the encoded extension list information; and
communicate based on the received configuration information.

19. The apparatus of claim 1, wherein the extension list information corresponds to UE capability information.

20. The apparatus of claim 1, wherein the processing system configured to encode the extension list information includes to:
Abstract Syntax Notation One (ASN.1) encode the extension list information using one or more index indications of the index indication information to generate the encoded extension list information.
